(19) United States
(12) Patent Application Publication
(10) Pub. No.: US 2004/0222049 A1
(43) Pub. Date: Nov. 11, 2004

(54) Park brake for a disc brake system and disc brake system incorporating same

(76) Inventors: Stan Nowak, Balcatta WA (AU); Dorota H. Kieronska, Balcatta WA (AU); Vin C. Morley, Balcatta WA (AU)

Correspondence Address: ROTHWELL, FIGG, ERNST & MANBECK, P.C., 1425 K STREET, N.W., SUITE 800, WASHINGTON, DC, 20005, US

(21) Appl. No.: 10/488,788

(22) PCT Filed: Aug. 30, 2002
(86) PCT No.: PCT/AU02/01191

(30) Foreign Application Priority Data
Sep. 7, 2001 (AU) PR 7554

(51) Int. Cl. F16D 55/08

(52) U.S. Cl. 188/72.1

(57) ABSTRACT

A park brake (14) is incorporated into a housing (10) of a disc brake system (12). The housing (10) is in the form of an annular ring having a plurality of cavities (16) for housing service brake pistons which act on brake pads (18) to selectively force the brake pads (18) onto a brake disc to produce a surface brake effect. The park brake (14) includes an actuator (23) supported by the housing (10) which is switchable between an applied state where it forces the brake pad (18) into contact with the brake disc of the system (10) independent of the action of the service brake pistons to produce a park brake effect, and a released state where the actuator (23) allows the brake pad (18) to become disengaged from the brake disc. The. actuator (23) includes a hydraulically operated park brake piston (27) having a rod (24) extending therefrom. The rod (24) is slidably retained within a hole (26) formed in the housing (10) and is arranged to abut or otherwise apply force to the brake pad (18). When fluid pressure is applied to the pad brake piston (27) it retracts the rod (27) into the housing (10) releasing the park brake (14). In the absences of the application of fluid pressure, a spring (34) of the actuator (23) operates to switch the actuator (23) to an applied state where the rod (24) pushes on the pad (18) forcing it into contact with the brake disc thereby providing the park brake effect.

### FIELD OF THE INVENTION

The present invention relates to a park brake for a disc brake system and, to a disc brake system incorporating said park brake.

### BACKGROUND OF THE INVENTION

Typically, a park brake for a disc brake system includes a drum attached to a brake disc and a pair of brake shoes adapted for engaging an inside surface of the drum. The brake shoes are usually moved into contact with the drum by pulling on a brake lever.

The provision of a park brake in this manner for a disc brake system involves significant expense, and adds additional weight and complexity to the braking system.

Throughout this specification the term “comprising” is used inclusively, in the sense that there may be other features and/or steps included in the invention not expressly defined or comprehended in the features or steps subsequently defined or described. What such other features and/or steps may include will be apparent from the specification read as a whole.

### SUMMARY OF THE INVENTION

According to a first aspect of the present invention there is provided a park brake for a disc brake system having a housing in which is disposed at least one service brake piston and having an associated brake pad on which said at least one piston can act for engaging said brake pad with a brake disc, said park brake comprising:

an actuator supported by said housing and operatively associated with said brake pad, said actuator switchable between an applied state where said actuator forces said brake pad into engagement with said brake disc independent of action of said service brake piston, and a released state where said actuator allows said brake pad to disengage said brake disc.

Preferably said actuator comprises bias means for biasing said actuator into said applied state.

Preferably said actuator comprises a member arranged to abut or otherwise transfer force to said brake pad and operational means for moving said member into contact with said brake pad and forcing said brake pad into engagement with said brake disc when said actuator is in said applied state.

Preferably, said operational means comprises hydraulic means supported by said housing for moving said member into contact with said brake pad and forcing said brake pad into engagement with said brake disc when said actuator is in said applied state.

Preferably said hydraulic means includes a piston and said member is a rod extending from said piston.

Alternately said operational means comprises a mechanical linkage coupled to said housing and said member for moving said member into contact with said brake pad and forcing said brake pad into engagement with said brake disc when said actuator is in said applied state.

In a further alternate embodiment, said operational means comprises electrical means supported by said housing and coupled to said member for moving said member into contact with said brake pad and forcing said brake pad into engagement with said brake disc when said actuator is in said applied state. In this embodiment, said electrical means includes a solenoid wherein said member constitutes a plunger of said solenoid.

According to another aspect of the present invention, there is provided a disc brake system commprising:

a service brake comprising a housing in which is disposed at least one service brake piston, and a brake pad associated with said at least one service brake piston;

a rotatable brake disc adjacent said housing which said brake pad can selectively engage for providing a service braking effect; and

a park brake comprising an actuator supported by said housing and operatively associated with said brake pad, said actuator switchable between an applied state where said actuator forces said brake pad into engagement with said brake disc independent of action of said service brake piston, and a released state where said actuator allows said brake pad to disengage said brake disc.

Preferably said service brake comprising one or more pairs of service brake pistons wherein a single brake pad is associated with each pair of service brake pistons; and wherein said park brake includes an actuator disposed intermediate the service brake pistons in each of said pair of pistons.

### BRIEF DESCRIPTION OF THE DRAWINGS

An embodiment of the present invention will now be described by way of example only with reference to the accompanying drawings in which:

FIG. 1 is a plan view of a body of a disc brake system incorporating an embodiment of the park brake;

FIG. 2 is a view of section AA taken through the body depicted in FIG. 1 when a brake pad incorporated in the disc brake system is at a maximum state of wear;

FIG. 3 is a view of section AA taken through the body depicted in FIG. 1 when a brake pad incorporated in the disc brake system is at a state of no wear;

FIG. 4 is a plan view of a spring and piston housing incorporated in the park brake;

FIG. 5 is a view through section BB of the housing depicted in FIG. 4;

FIG. 6 is a view through section CC of the housing depicted in FIG. 4; and,

FIG. 7 is a view through section DD of the housing depicted in FIG. 4.

### DETAILED DESCRIPTION OF PREFERRED EMBODIMENTS

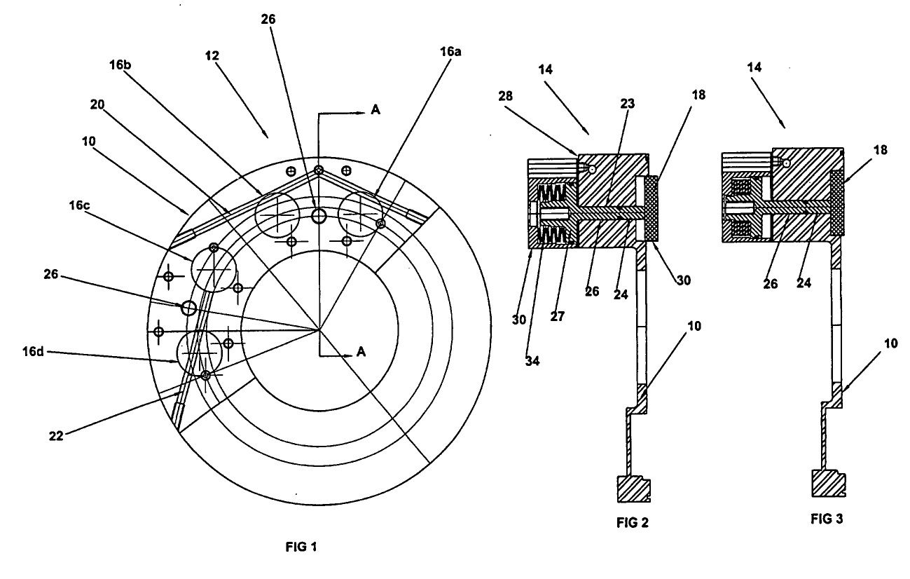

FIGS. 1-3 depict a housing 10 of a disc brake system 12 which incorporates an embodiment of the park brake 14 in accordance with the present invention. The housing 10 is in the form of an annular ring provided with a plurality of cavities 16a-16d (hereinafter referred to in general as “cavities 16”) for housing service brake pistons (not shown). In this particular embodiment, the service brake pistons operate in pairs with the pistons housed in cavities 16a and 16b forming one pair, and those housed in cavities 16c and 16d operating as a second pair. Respective brake pads 18 (only one shown in FIGS. 2 and 3) are associated with each piston pair. The pairs of pistons in cavities 16 and their associated brake pads 18 form, or operate as, the service brake in the disc brake system 12.

A fluid gallery 20 is provided internally of the housing 10 for providing pressurised fluid to cavities 16a and 16b to force the corresponding service brake pistons and thus the associated brake pad 18 into engagement with a brake disc (not shown) attached to a rotating axle (not shown). A further gallery 22 is formed in the housing 10 to provide pressurised fluid to the brake pistons housed within cavities 16c and 16d for likewise forcing an associated brake pad 18 into engagement with the brake disc.

The housing 10 may include further cavities 16 for providing additional service brakes. The specific configuration of cavities 16 is not critical to the present invention. Nevertheless, advantageously, the cavities 16 and the service brake pistons (not shown) housed within the cavities 16 may be in the form depicted in Applicant's corresponding Application No. PR7395, the contents of which are incorporated herein by way of reference. Further, an alternate form of housing 10 which may be incorporated in reference. Further, an alternate form of housing 10 which may be incorporated in embodiments of the present invention may be in the form depicted in Applicant's corresponding Provisional Application No. PR7393, the contents of which is incorporated herein by way of reference.

The park brake 14 in accordance with an embodiment of the present invention includes an actuator 23 supported by the housing 10 and operatively associated with a brake pad 18. The actuator 23 is switchable between an applied state (shown in FIG. 2) where it forces the brake pad 18 into contact with the brake disc of the system 10 independent of the action of the service brake pistons to produce a park brake effect, and a released state (shown in FIG. 3) where the actuator allows the brake pad 18 to become disengaged from the disc. The actuator 23 has a member in the form of a rod 24 that is slidably retained within transverse hole 26 formed in the housing 10, and an operation means in the form of a hydraulic park brake piston 27 for moving the rod 24. In this particular embodiment, two park brakes are incorporated in the brake system 12 shown in FIG. 1. Advantageously, each park brake 14 and corresponding hole 26 is disposed between the service brake pistons (not shown) which constitute the abovementioned piston pairs housed within cavity 16a and 16b; and, 16c and 16d. The rod 24 constitutes an axial extension of an associated park brake piston 27. The holes 26 extend for the full width of the housing 10 and are closed at a back face 28 of the housing 10 by a respective park brake piston housing 30 (also hereinafter referred to as “actuator casing” 30) which house the park brake piston 27.

Bias means in the form of a bellville spring 34 acts between the piston 27 and the housing 30 to bias the actuator 23 toward an applied state. In the applied state, the rod 24 acts on the pad 18 (which is associated with the service brake pistons housed in the adjacent cavities 16) forcing it into contact with the brake disc (not shown) of the disc brake system 12. This action is independent of the action provided by the service brake pistons held within the cavities 16. That is, the park brake 14 acts independently of the service brake.

In this particular embodiment, in order to switch the actuator 23 to a released state, i.e. to release the park brake 14, pressurised fluid is supplied to the housing 30 to act between the piston 27 and back face 28 of housing 10 to compress a spring 34 effectively retracting the rod 24 to allow the pad 18 to be disengaged or otherwise released from the brake disc.

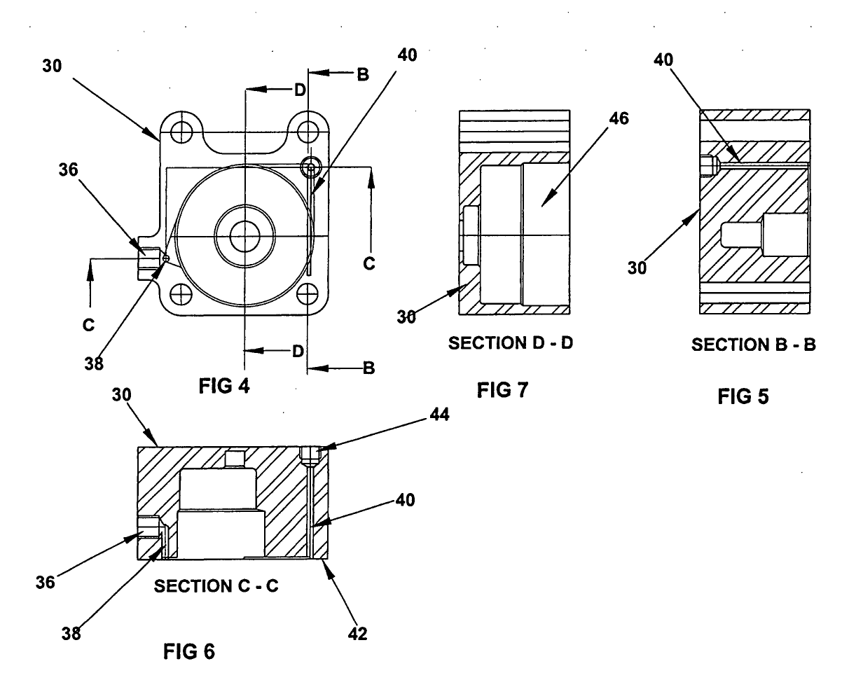

Referring to FIGS. 4-7, the actuator casing 30 is provided with a brake fluid inlet 36 which is placed in fluid communication with a master cylinder for supplying pressurised brake fluid to the park brake 14. The inlet 36 is in fluid communication with an internal duct 38 for directing the pressurised brake fluid to a region between the piston 27 and back face 28 of the housing 10.

Housing 30 also includes a bleed duct 40 which extends from between an inside face 42 and the back face 38 through the housing 30 to a bleed valve port 44. This allows the bleeding of brake fluid through the housing 30.

The housing 30 also includes a cavity 46 for housing the piston 27 and spring 34.

As mentioned above, the present illustrated park brake system 14 is released or operated by the application of fluid pressure, and is automatically or self applied in the absence of fluid pressure. This arrangement is particularly well adapted for use with Applicant's dual hydraulic brake circuit described in co-pending Provisional Application No. PR7394, the contents of which are incorporated herein by way of reference. In the dual hydraulic brake circuit, two master cylinders are incorporated, one being used as the primary master cylinder for providing fluid pressure to the service brakes while the other acts as a standby master cylinder in the event of failure of the primary master cylinder. However the standby master cylinder can be used with the present park brake system 14 for providing fluid pressure for releasing the park brake 14. In this regard, a solenoid activated valve (not shown) can be incorporated to allow pressure from the standby master cylinder to compress the spring 34 thus releasing the park brake. It will be appreciated that in such a system, when vehicle ignition is turned OFF, the master cylinders do not pressurise the brake fluid and accordingly, the park brake 14 is automatically deployed.

Now that an embodiment of the present invention has been described in detail it will be apparent to those skilled in the relevant arts that numerous modifications and variations may be made without departing from the basic inventive concepts. For example, depending on the size (diameter) of the housing 10 of the disc brake system 12, it may be possible to incorporate two rods 24 (and associated pistons 27) between the service brake pistons in each service brake piston pair. Also, in the depicted embodiment, the actuator 23 is described and illustrated as being hydraulically operated. However the actuator 23 may be operated by other means including by mechanical linkages and levers, or electrically. With an electrical actuator, the rods 24 may be formed as respective moving cores or plungers of solenoids which, when energised, is equivalent to switching the actuator to the released state, i.e. retracting the rods against the bias of spring 34, and when de-energised is equivalent to switching the actuator to the applied state, where the spring 34 is released thereby pushing the rods 24 and subsequently the brake pads 18 into engagement with the brake disc to provide a park brake effect.

All such modifications and variations are deemed to be within the scope of the present invention the nature of which is to be determined from the above description, and the appended claims.

1. A park brake for a disc brake system having a brake housing in which is disposed at least one service brake piston and having an associated brake pad on which said at least one piston can act for engaging said brake pad with a brake disc, said park brake comprising:
an actuator having an actuator casing adapted for coupling to said brake housing, said actuator including a member extending from said actuator casing and arranged to abut or otherwise transfer force to said brake pad, said actuator switchable between an applied state where said member forces said brake pad into engagement with said brake disc independent of action of said service brake piston, and a released state where said member allows said brake pad to disengage said brake disc.

2. A park brake according to claim 1 wherein said actuator comprises bias means for biasing said actuator into said applied state.

3. A park brake according to claim 2 wherein said actuator comprises operational means for moving said member into contact with said brake pad and forcing said brake pad into engagement with said brake disc when said actuator is in said applied state.

4. A park brake according to claim 3 wherein said operational means comprises hydraulic means disposed in said actuator casing for moving said member into contact with said brake pad and forcing said brake pad into engagement with said brake disc when said actuator is in said applied state.

5. A park brake according to claim 4 wherein said hydraulic means comprises a piston and said member is a rod extending from said piston.

6. A park brake according to claim 3 wherein said operational means comprises a mechanical linkage disposed in or supported by said actuator casing for moving said member into contact with said brake pad and forcing said brake pad into engagement with said brake disc when said actuator is in said applied state.

7. A park brake according to claim 3 wherein said operational means comprises electrical means supported by said housing and coupled to or otherwise associated with said member for moving said member into contact with said brake pad and forcing said brake pad into engagement with said brake disc when said actuator is in said applied state.

8. A park brake according to claim 7 wherein said electrical means comprises a solenoid wherein said member constitutes a plunger of said solenoid.

9. A disc brake system comprising at least:
a service brake comprising a housing in which is disposed at least one service brake piston, and a brake pad associated with said at least one service brake piston;
a rotatable brake disc adjacent said housing which said brake pad can selectively engage for providing a service braking effect; and
a park brake including an actuator having an actuator casing coupled to said housing, said actuator operatively associated with said brake pad and switchable between an applied state where said actuator forces said brake pad into engagement with said brake disc independent of action of said service brake piston, and a released state where said actuator allows said brake pad to disengage said brake disc.

10. The system according to claim 9 wherein said service brake comprising one or more pairs of service brake pistons wherein a single brake pad is associated with each pair of service brake pistons; and wherein said park brake includes an actuator disposed intermediate the service brake pistons in each of said pair of pistons.

11. The system according to claim 9 wherein said actuator comprises bias means for biasing said actuator into said applied state.

12. The system according to claim 11 wherein said actuator comprises a member extending from said actuator casing and arranged to abut or otherwise transfer force to said brake pad, and operational means for moving said member into contact with said brake pad and forcing said brake pad into engagement with said brake disc when said actuator is in said applied state.

13. The system according to claim 12 wherein said operational means comprises hydraulic means disposed in said actuator casing for moving said member into contact with said brake pad and forcing said brake pad into engagement with said brake disc when said actuator is in said applied state.

14. The system according to claim 13 wherein said hydraulic means comprises a piston and said member is a rod extending from said piston.

15. The system according to claim 12 wherein said operational means comprises a mechanical linkage disposed in or supported by said actuator housing and said member for moving said member into contact with said brake pad and forcing said brake pad into engagement with said brake disc when said actuator is in said applied state.

16. The system according to claim 12 wherein said operational means comprises electrical means disposed in said actuator housing and coupled to or otherwise associated with said member for moving said member into contact with said brake pad and forcing said brake pad into engagement with said brake disc when said actuator is in said applied state.

17. The system according to claim 16 wherein said electrical means comprises a solenoid wherein said member constitutes a plunger of said solenoid.

18. A park brake for a disc brake system having a brake housing in which is disposed at least one service brake piston and having an associated brake pad on which said at least one piston can act for engaging said brake pad with a brake disc, said park brake comprising:
an electrical actuator having an actuator casing adapted for coupling to said brake housing, said electrical actuator comprising a solenoid having a plunger extending from said actuator casing and arranged to abut or otherwise transfer force to said brake pad and bias means for biasing said actuator into an applied state where said plunger forces said brake pad into engagement with said brake disc independent of action of said service brake piston, said actuator switchable between said applied state and a released state where said member allows said brake pad to disengage said brake disc.

19. A disc brake system comprising:
a service brake having a housing in which is disposed at least one serviced brake piston, and a brake pad associated with said at least one service brake piston;
a rotatable brake disc adjacent said housing which said brake pad can selectively engage for providing a service braking effect; and
a park brake comprising an electrical actuator having an actuator casing coupled to said housing, said electrical actuator comprising a solenoid having a plunger arranged to abut or otherwise apply force to said brake pad and bias means for biasing said actuator into an applied state where said plunger forces said brake pad into engagement with said brake disc independent of action of said service brake piston against said bias means, said electrical actuator switchable between said applied state and a released state where said actuator allows said brake pad to disengage said brake disc.

20. The system according to claim 19 wherein said service brake comprises one or more pairs of service brake pistons wherein a single brake pad is associated with each pair of service brake pistons; and wherein said park brake includes an electrical actuator disposed intermediate the service brake pistons in each of said pair of pistons.
